(19) United States
(12) Patent Application Publication
(10) Pub. No.: US 2015/0043427 A1
(43) Pub. Date: Feb. 12, 2015

(54) METHOD AND APPARATUS FOR CONNECTION IN A BLUETOOTH COMMUNICATION SYSTEM

(71) Applicant: Vishwanath . K.M., Bangalore (IN)

(72) Inventor: Vishwanath . K.M., Bangalore (IN)

(21) Appl. No.: 14/232,619

(22) PCT Filed: Jul. 18, 2012
(86) PCT No.: PCT/US2012/047109

§ 371 Date: Jan. 14, 2014

(30) Foreign Application Priority Data
Jul. 25, 2011 (IN) 977/KOL/2011

(51) Int. Cl. H04W 8/22; H04W 8/00; H04W 4/00; H04W 76/02

(52) U.S. Cl. CPC H04W 8/22; H04W 76/023; H04W 8/005; H04W 4/008
USPC 370/328

(57) ABSTRACT

A Bluetooth communication system is provided wherein a remote, or destination, wireless communication device provides its Bluetooth profile information, including all of the necessary Service Discovery Protocol (SDP) information required to initiate a profile connection, to a source wireless communication device in an Extended Inquiry Response (EIR) message as part of Device discovery or Inquiry procedure. In response, the source wireless communication device will establish an ACL connection with the remote wireless communication device and provide its own EIR message containing the necessary SDP information of the source wireless communication device over ACL connection as an ACL data packet. The manufacturer data field of the EIR messages will include the SDP information of the respective devices. Thus the Bluetooth communication system preserves the overhead that would be expended in establishing a Layer Logical Link Control and Adaption Protocol layer (L2CAP) connection and exchanging multiple SDP requests and responses.

### FIELD OF THE INVENTION

The present invention relates generally to Bluetooth communication systems and in particular to procedure for connection in a Bluetooth communication system.

### BACKGROUND OF THE INVENTION

With the advent of wireless communications, short range wireless systems have been developed that allow an audio source, such as a Bluetooth-enabled cellular telephone or music player, to wirelessly transmit user data, such as music or a voice communication, to an audio sink, such as a Bluetooth enabled desktop speaker or a Bluetooth headset. However, establishing a profile connection for the conveyance of the user data can be excessively time consuming when a user is attempting to connect his or her Bluetooth-enabled cellular telephone to a speaker, for example, when setting up a phone call utilizing remote Bluetooth-enabled speakers such as speakers of a user's automobile.

Therefore a need exists for a method and an apparatus for expediting a set up of a Bluetooth wireless connection.

### BRIEF DESCRIPTION OF THE DRAWINGS

FIG. 1 is a block diagram of a Bluetooth communication system in accordance with an embodiment of the present invention.

FIG. 2 is a block diagram of a source wireless communication device of the Bluetooth communication system of FIG. 1 in accordance with an embodiment of the present invention.

FIG. 3 is a block diagram of a destination wireless communication system of the

Bluetooth communication system of FIG. 1 communication system in accordance with an embodiment of the present invention.

FIG. 4 is a block diagram illustrating exemplary protocol stacks of the communication devices of the Bluetooth communication system of FIG. 1 in accordance with an embodiment of the present invention.

FIG. 5 is a logic flow diagram illustrating an establishment of a profile connection between the source wireless communication device and the destination wireless communication device of the Bluetooth communication system of FIG. 1 in accordance with various embodiments of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and an apparatus for expediting a set up of a Bluetooth wireless connection, a Bluetooth communication system is provided wherein a remote, or destination, wireless communication device provides its Bluetooth profile information, including all of the necessary Service Discovery Protocol (SDP) information required to initiate a profile connection, to a source wireless communication device in an Extended Inquiry Response (EIR) message as part of Device discovery or Inquiry procedure. In response, the source wireless communication device will establish an ACL connection with the remote wireless communication device and provide its own EIR message containing the necessary SDP information of the source wireless communication device over ACL connection. The manufacturer data field of the EIR messages will include the SDP information of the respective devices. Thus the Bluetooth communication system preserves the overhead that would be expended in establishing a Layer Logical Link Control and Adaption Protocol layer (L2CAP) connection and exchanging multiple SDP requests and responses.

Generally, an embodiment of the present invention encompasses a method for establishing a connection in a Bluetooth communication system. The method includes discovering a remote wireless communication device, receiving, from the remote wireless communication device, an EIR message comprising Bluetooth profile information associated with the remote wireless communication device in a manufacturer data field of EIR, wherein the Bluetooth profile information comprises SDP information, and establishing a profile connection based on the Bluetooth profile information included in the manufacturer data field of the EIR message.

Another embodiment of the present invention encompasses a method for negotiating a connection in a Bluetooth communication system. The method includes receiving an inquiry packet from a wireless communication device, in response to receiving the inquiry packet, assembling an EIR message comprising Bluetooth profile information associated with the wireless communication device wherein the Bluetooth profile information comprises Service Discovery Protocol information, and conveying the EIR message to the remote wireless communication device.

Still another embodiment of the present invention encompasses a wireless communication device capable of operating in a Bluetooth communication system. The wireless communication device includes a radio frequency (RF) receiver and an at least one memory device that maintains Bluetooth profile information associated with the wireless communication device, wherein the Bluetooth profile information comprises SDP information. The wireless communication device further includes a processor that is configured to discover a remote wireless communication device, receive, via the RF receiver and from the remote wireless communication device, an EIR message comprising Bluetooth profile information associated with the remote wireless communication device, wherein the Bluetooth profile information comprises SDP information associated with the remote wireless communication device, and establish a profile connection based on the Bluetooth profile information included in a manufacturer data field in the EIR message.

Yet another embodiment of the present invention encompasses a wireless communication device capable of operating as a remote wireless communication device in a Bluetooth communication system. The wireless communication device includes and RF receiver, an RF transmitter, and an at least one memory device that maintains Bluetooth profile information associated with the wireless communication device wherein the Bluetooth profile information comprises SDP information. The wireless communication device further includes a processor that is configured to receive, via the radio frequency receiver, a inquiry packet from another wireless communication device, in response to receiving the inquiry packet, assemble an EIR message comprising the Bluetooth profile information, and convey, via the radio frequency transmitter, the EIR message to the another wireless communication device.

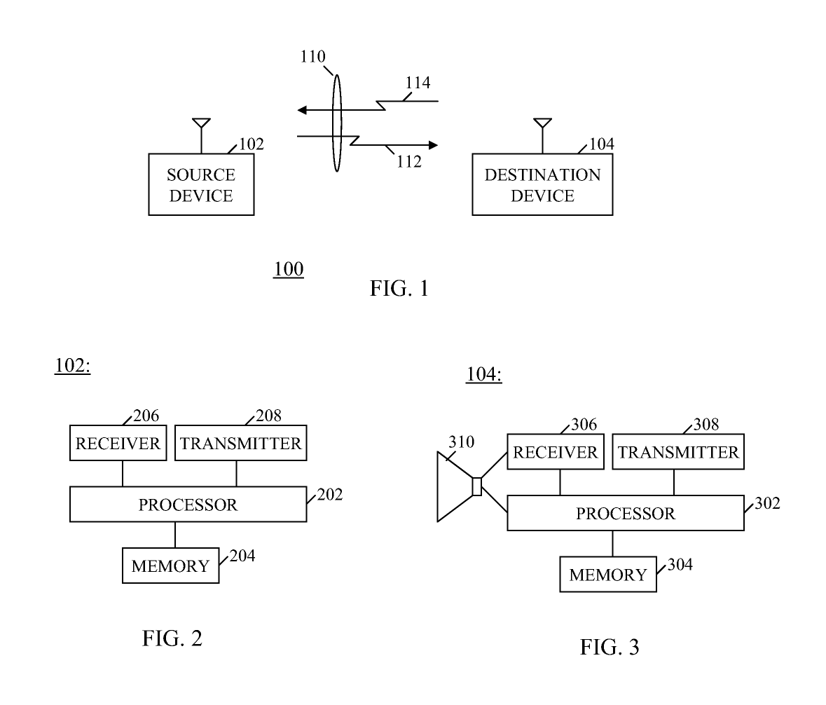

The present invention may be more fully described with reference to FIGS. 1-5. FIG. 1 is a block diagram of a Bluetooth communication system 100 in accordance with an embodiment of the present invention. Communication system 100 includes multiple wireless communication devices 102, 104 (two shown). A first wireless communication device 102 of the multiple wireless communication devices 102, 104 functions as a data source in communication system 100 and also may be referred to herein as a source wireless communication device. Source wireless communication device 102 may be, for example, a Bluetooth-enabled mobile station, such as a cell phone, a smartphone, a wireless music player, such as an MP3 player, or a laptop computer equipped for Bluetooth wireless communications, or may be a desktop computer equipped for Bluetooth wireless communications. A second wireless communication device 104 of the multiple wireless communication devices 102, 104 resides within a listening area covered by source wireless communication device 102 and functions as a data sink in communication system 100, and also may be referred to herein as a sink wireless communication device, a remote wireless communication device, or a destination wireless receiving device. For example, destination wireless communication device 104 may be a Bluetooth-enabled stereo loudspeaker or a Bluetooth-enabled headphone.

Source wireless communication device 102 communicates with destination wireless communication device 104 via a radio link 110. Radio link 110 comprises a downlink 112 and an uplink 114 that each comprises multiple physical channels and logical channels. For example, each of downlink 112 and uplink 114 of radio link 110 includes one or more control channels, and downlink 112 further includes one or more user data channels.

Referring now to FIGS. 2 and 3, each of source wireless communication device 102 and destination wireless communication device 104 includes a respective processor 202, 302, such as one or more microprocessors, microcontrollers, digital signal processors (DSPs), combinations thereof or such other devices known to those having ordinary skill in the art, which processor is configured to execute the functions described herein as being executed by the wireless communication device. Each of source wireless communication device 102 and destination wireless communication device 104 further includes a respective at least one memory device 204, 304 that may comprise random access memory (RAM), dynamic random access memory (DRAM), and/or read only memory (ROM) or equivalents thereof, that maintain data and programs that may be executed by the associated processor and that allow the wireless communication device to perform all functions necessary to operate in communication system 100. Each of the at least one memory devices 204, 304 further maintains Bluetooth profile information associated with the corresponding wireless communication device as known in the art.

Each of source wireless communication device 102 and destination wireless communication device 104 further includes a respective radio frequency (RF) receiver 206, 306 and RF transmitter 208, 208 in communication with processor 202 and for wirelessly communicating with another Bluetooth device, that is, for receiving Bluetooth signals from, and wirelessly transmitting Bluetooth signals to, other Bluetooth wireless communication devices. In addition, destination wireless communication device 104 may include a speaker module 310 in communication with the processor and with receiver 306, which speaker module 310 includes an input (not shown) and an output (not shown), wherein the input receives an audio signal that then is amplified and output to a user at the output of the speaker as known in the art.

In order for source wireless communication device 102 to engage in a communication session with destination wireless communication device 104, each wireless communication device 102, 104 operates in accordance with known Bluetooth communication standards. Preferably, communication system 100 is a Bluetooth 2.1, or higher, communication system that operates in accordance with the Bluetooth A2DP (Advanced Audio Distribution Profile) standards, wherein a physical channel, such as the channels of radio links 110, comprises one or more time slots of a group of time slots, which group of time slots are frequency hopped over multiple frequencies of a given frequency bandwidth. To ensure compatibility, radio system parameters and communication session procedures are specified by the standards, including communication session set up steps that are executed by the source and destination wireless communication devices. However, one of ordinary skill in the art realizes that communication system 100 may be any wireless communication system that in accordance with a Bluetooth standard.

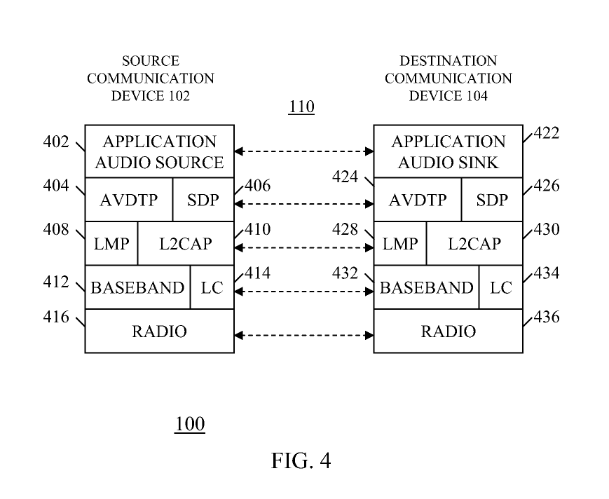

Referring now to FIG. 4, exemplary protocol stacks of wireless communication devices 102 and 104 of communication system 100 are depicted in accordance with an embodiment of the present invention. Communication system 100 is a Bluetooth communication system that implements well-known Bluetooth protocol stacks. For example, a top layer, or Application Layer, 402, 422 of each of wireless communication devices 102 and 104 may include an application audio source that sources user data for transmission to a destination wireless communication device and an application audio sink that processes the received user data for output to a user at a destination wireless communication device. A next layer down may comprise a Service Layer that includes an Audio/Video Distribution Transport Protocol layer (AVDTP) 404, 424 and a Service Discovery Protocol layer (SDP) 406, 426. AVDTP is a transport protocol based on the Real Time Protocol (RTP) and applies point-to-point signaling between two wireless communication devices over an L2CAP channel, including exchanges of SDP messages to discover the Bluetooth attributes of another wireless communication device, Quality of Service (QoS) and transport status reporting, and data stream set-up, reconfiguration, and tear down signaling.

A next layer down from the Service Layer may comprise a Link Layer that includes a Link Manager Protocol layer (LMP) 408, 428 and a Layer Logical Link Control and Adaption Protocol layer (L2CAP) 410, 430. The LMP is responsible for the creation and management of logical links between devices and logical transports between devices, encryption on the logical transports, and control of physical link transmit power and QoS settings. The L2CAP supports transmission and reception of data packets by higher layer protocols and supports packet segmentation and reassembly, exchange of QoS information, and per-channel flow control and retransmissions. For example, the L2CAP provides for resource management including segmentation of higher layer service data units (SDUs) into smaller protocol data units (PDUs), fragmentation of the PDUs into data packets for submission to the Baseband Layer and transmission over an air interface, and buffer management to ensure availability for channels and a given Quality of Service (QoS). The L2CAP further may provide error detection and retransmission of L2CAP PDUs. The L2CAP also provides logical channels, and each endpoint of a logical channel is defined by a channel identifier (CID). In Bluetooth, each wireless communication device can assign CIDs independent of assignments made by other wireless communication devices.

A next layer down from the Link Layer may comprise a Baseband Layer that includes a Baseband Manager 412, 432 and a Link Controller 414, 434. The Baseband Manager includes a scheduling function that negotiates access to, and grants time on, the physical channels. The Link Controller is responsible for communication of flow control, acknowledgments, and retransmission request signals. A bottom layer may comprise a Physical Layer that includes RF functionality 416, 436 responsible for transmitting and receiving packets on the physical channels. The RF functionality transforms a stream of data received from the Baseband Layer to a format for transmission over a physical channel and transforms data received from the physical channel to a format appropriate for the Baseband Layer.

Preferably, each of the Application Layer, Service Layer, Link Layer, and Baseband Layer is implemented by the processor 202, 302 of a wireless communication device 102, 104 based on programs and instructions maintained in the corresponding at least one memory device 204, 304 of the wireless communication device. Additionally, the RF functionality preferably is implemented by the transmitter/receiver of the wireless communication device, whichever is appropriate.

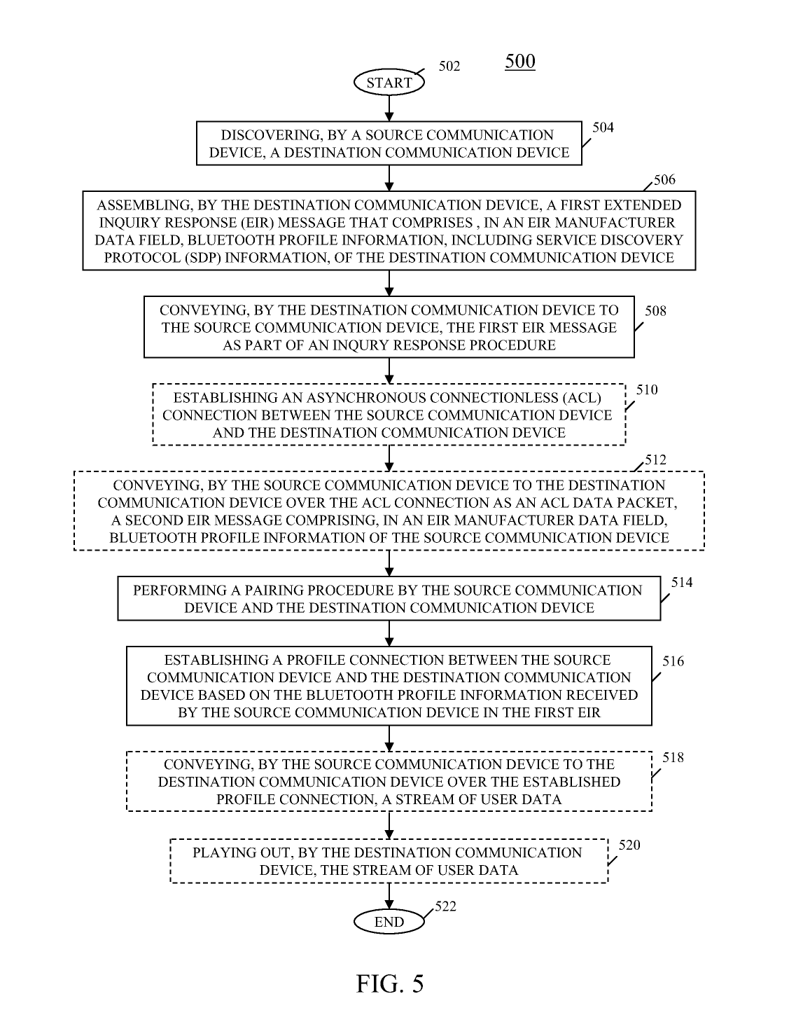

Referring now to FIG. 5, a logic flow diagram 500 is provided that illustrates a negotiation of a connection between source wireless communication device 102 and destination wireless communication device 104 in accordance with various embodiments of the present invention. Logic flow diagram 500 begins (502) when source wireless communication device 102 discovers (504) destination wireless communication device 104, preferably in accordance with known Bluetooth inquiry procedures. For example, source wireless communication device 102 may broadcast an inquiry packet via downlink 112 of radio link 110. In response to receiving the inquiry packet, destination wireless communication device 104 transmits an inquiry reply back to the source wireless communication device via a control channel of uplink 114 of radio link 110.

In the prior art, before a source wireless communication device, such as wireless communication device 102, could establish a profile connection to a discovered destination wireless communication device, such as destination wireless communication device 104, the source wireless communication device would first establish an ACL connection. After establishing the ACL connection, initiating pairing, and establishing the L2CAP connection, the source wireless communication device then obtained the Bluetooth profile information of the destination wireless communication device by conveying a Service Discovery Protocol (SDP) request to the destination wireless communication device and, in response, receiving an SDP response from the destination wireless communication device, which SDP response comprises the requested Bluetooth profile information. This most of the times require multiple exchanges of SDP requests and responses. After the source wireless communication device obtained all of the SDP information required to initiate a profile connection for the individual profiles supported by the destination wireless communication device, the source wireless communication device closed the L2CAP connection and would initiate a profile connection. This entire process of establishing ACL and L2CAP connections and exchanging SDP requests and responses typically takes six to seven seconds or more.

In order to expedite initiation of a profile connection between source wireless communication device 102 and destination wireless communication device 104, communication system 100 provides for destination wireless communication device 104 to provide to source wireless communication device 102, in response to being discovered, for example, to receiving the inquiry packet, all of the SDP information required to initiate a profile connection in an Extended Inquiry Response (EIR) message, for example, within a manufacturer data field of the EIR message. In response to receiving the EIR message, source wireless communication device 102 now has all the information that the device needs to successfully establish a connection to the destination wireless communication device, circumventing the waiting time associated with the establishment of the L2CAP connection and bypassing the need to establish the L2CAP connection for SDP and multiple SDP requests and responses.

That is, and referring again to FIG. 5, in response to being discovered, that is, receiving the broadcast of source wireless communication device 102, destination wireless communication device 104 assembles (506) a first EIR message and includes, in the EIR message and preferably in a manufacturer data field of the EIR message, the device's Bluetooth profile information indicating services supported by the destination wireless communication device and the services' associated parameters. For example, each supported service may be identified by a Universally Unique Identifier (UUID), in either a short form (16 bits) or a full form (128 bits). The Bluetooth profile information may comprise SDP information that is used for determining which Bluetooth profiles are supported by the destination wireless communication device, for example, Headset Profile, Hands Free Profile, Advanced Audio Distribution Profile (A2DP), and so on, and the protocol multiplexer settings, for example, a Server Channel Number (SCN) and Protocol Service Multiplexer (PSM) value, and other SDP attributes needed to connect to each profile. Destination wireless communication device 104 then conveys (508) to source wireless communication device 102, and the source wireless communication device receives from the destination wireless communication device, the first EIR message.

In response to receiving the first EIR message, source wireless communication device 102 now has all the information that the device needs to successfully establish a connection to the destination wireless communication device. Source wireless communication device 102 and destination wireless communication device 104 then may establish (510) an ACL connection in accordance with known techniques, for example, by the source wireless communication device initiating the ACL connection to the destination wireless communication device and the destination wireless communication device then accepting the connection. In response to the establishment of the ACL connection, source wireless communication device 102 may convey (512), to destination wireless communication device 104 over the established ACL connection and as an ACL data packet, a second EIR message that includes, in the second EIR message and preferably in a manufacturer data field of the second EIR message, the source wireless communication device's Bluetooth profile information, such as SDP information, indicating services supported by the device and the services' associated parameters. By providing the source wireless communication device's SDP information to the destination wireless communication device, the destination wireless communication device has all the information that the destination wireless communication device might need in the event that the destination wireless communication device has to establish a reconnection to the source wireless communication device.

Source wireless communication device 102 then performs (514) a pairing procedure with destination wireless communication device 104 in accordance with known techniques and, based on the Bluetooth profile information associated with, and received from, the destination wireless communication device in the first EIR message, establishes (516) a profile connection with the destination wireless communication device. For example, source wireless communication device may assign, and convey to destination wireless communication device, at least one channel identifier (CID) assigned by source wireless communication device 102 to the connection (for example, source wireless communication device 102 may assign a CID to each logical channel of multiple logical channels to be included in a broadcast of user data) and time slot and hopping pattern information with respect to the physical channel(s) to be employed in the connection.

Further, destination wireless communication device 104 may convey to source wireless communication device 102 a CID assigned by the destination wireless communication device to the connection. Other exchanged profile connection parameters may include device identifiers, profile supported formats, supported features, supported codec capabilities, and so on.

Subsequent to establishing the profile connection with first destination wireless communication device 104, source wireless communication device 102 may convey (518), to destination wireless communication device 104, a stream of user data packets over the established profile connection. Destination wireless communication device 104 then may process the received data packets in accordance with well-known techniques and may play out (520) the processed data packets via speaker module 310, and logic flow 500 then ends (522).

By destination wireless communication device 104 providing its Bluetooth profile information, including all of the SDP information required to initiate a profile connection, to source wireless communication device 102 in an EIR message that the destination wireless communication device conveys in response to receiving an inquiry packet from the source wireless communication device, communication system 100 preserves the overhead that would be expended in establishing an L2CAP connection and exchanging multiple SDP requests and responses. Furthermore, communication system 100 expedites a setting up of a profile connection by bypassing these steps and by providing for an earlier provision of the destination wireless communication device's Bluetooth profile information in the negotiation of a connection. In addition, by reducing the amount of signaling involved in a setting up of a profile connection, communication system 100 provides of a conservation of wireless communication device power, thereby extending the life of a limited life power supply of a portable wireless communication device.

Unless otherwise specified herein, the functionality described herein as being performed by source wireless communication device 102 and destination wireless communication device 104 is implemented with or in software programs and instructions stored in the respective at least one memory device 204, 304 associated with the transmitting and destination wireless communication devices and executed by the processor 202, 302 associated with the transmitting and destination wireless communication devices. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the transmitting and destination wireless communication devices. Based on the present disclosure, one skilled in the art will be readily capable of producing and implementing such software and/or hardware without undo experimentation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for establishing a connection in a Bluetooth communication system, the method comprising:
discovering a remote wireless communication device;
receiving, from the remote wireless communication device, an Extended Inquiry Response message comprising Bluetooth profile information associated with the remote wireless communication device in a manufacturer data field of the Extended Inquiry Response message, wherein the Bluetooth profile information comprises Service Discovery Protocol information; and
establishing a profile connection based on the Bluetooth profile information included in the manufacturer data field of the Extended Inquiry Response message.

2. The method of claim 1, further comprising, subsequent to receiving the Extended Inquiry Response message comprising the Bluetooth profile information, establishing an Asynchronous Connectionless connection with the remote wireless communication device.

3. The method of claim 2, further comprising conveying, to the remote wireless communication device over the Asynchronous Connectionless connection, Bluetooth profile information of the source wireless communication device.

4. The method of claim 3, wherein the Bluetooth profile information of the source wireless communication device comprises Service Discovery Protocol information.

5. The method of claim 1, further comprising conveying user data to the remote wireless communication device over the established profile connection.

6. A method for negotiating a connection in a Bluetooth communication system, the method comprising:
receiving an inquiry packet from a wireless communication device;
in response to receiving the inquiry packet, assembling an Extended Inquiry Response message comprising Bluetooth profile information associated with the wireless communication device wherein the Bluetooth profile information comprises Service Discovery Protocol information; and
conveying the Extended Inquiry Response message to the remote wireless communication device.

7. The method of claim 6, further comprising, subsequent to conveying the Extended Inquiry Response message comprising the Bluetooth profile information, establishing an Asynchronous Connectionless connection with the wireless communication device.

8. The method of claim 7, further comprising receiving, via the Asynchronous Connectionless connection, Bluetooth profile information associated with the wireless communication device.

9. The method of claim 6, further comprising establishing a profile connection with the wireless communication device.

10. The method of claim 9, further comprising receiving user data over the established profile connection.

11. A wireless communication device capable of operating in a Bluetooth communication system, the wireless communication device comprising:
a radio frequency receiver;
an at least one memory device that maintains Bluetooth profile information associated with the wireless communication device, wherein the Bluetooth profile information comprises Service Discovery Protocol information; and
a processor that is configured to discover a remote wireless communication device, receive, via the RF receiver and from the remote wireless communication device, an Extended Inquiry Response message comprising Bluetooth profile information associated with the remote wireless communication device, wherein the Bluetooth profile information comprises Service Discovery Protocol information associated with the remote wireless communication device, and establish a profile connection based on the Bluetooth profile information included in a manufacturer data field in the Extended Inquiry Response message.

12. The wireless communication device of claim 11, wherein the processor is configured to, subsequent to receiving the Extended Inquiry Response message comprising the Bluetooth profile information, establish an Asynchronous Connectionless connection with the remote wireless communication device.

13. The wireless communication device of claim 12, wherein the wireless communication device comprises a radio frequency transmitter and wherein the processor is configured to convey, to the remote wireless communication device via the radio frequency transmitter and over the Asynchronous Connectionless connection, Bluetooth profile information associated with the wireless communication device.

14. The wireless communication device of claim 13, wherein the Bluetooth profile information associated with the wireless communication device comprises Service Discovery Protocol information.

15. The wireless communication device of claim 11, wherein the processor is configured to convey, via the radio frequency transmitter, user data to the remote wireless communication device over the established profile connection.

16. A wireless communication device capable of operating as a remote wireless communication device in a Bluetooth communication system, the wireless communication device comprising:
a radio frequency receiver;
a radio frequency transmitter;
an at least one memory device that maintains Bluetooth profile information associated with the first wireless communication device wherein the Bluetooth profile information comprises Service Discovery Protocol information; and
a processor that is configured to receive, via the radio frequency receiver, a inquiry packet from another wireless communication device, in response to receiving the inquiry packet, assemble an Extended Inquiry Response message comprising the Bluetooth profile information, and convey, via the radio frequency transmitter, the Extended Inquiry Response message to the another wireless communication device.

17. The wireless communication device of claim 16, further comprising, subsequent to conveying the Extended Inquiry Response message comprising the Bluetooth profile information, establishing an Asynchronous Connectionless connection with the another wireless communication device.

18. The wireless communication device of claim 17, further comprising receiving, via the Asynchronous Connectionless connection, Bluetooth profile information associated with the another wireless communication device.

19. The wireless communication device of claim 16, further comprising establishing a profile connection with the another wireless communication device.

20. The wireless communication device of claim 19, further comprising receiving user data from the another wireless communication device over the established profile connection.
